(19) United States
(12) Patent Application Publication
(10) Pub. No.: US 2012/0183247 A1
(43) Pub. Date: Jul. 19, 2012

(54) ELECTRIC MACHINE WITH INTEGRATED BEARING TEMPERATURE SENSOR

(75) Inventors: Bradley D. Chamberlin, Pendleton, IN (US); David A. Fulton, Anderson, IN (US)

(73) Assignee: REMY TECHNOLOGIES, L.L.C., Pendleton, IN (US)

(21) Appl. No.: 13/007,154

(22) Filed: Jan. 14, 2011

(51) Int. Cl. F16C 32/00

(52) U.S. Cl. 384/448

(57) ABSTRACT

An electric machine includes a housing and a shaft arranged within the housing. The shaft includes a first end portion and a second end portion. At least one bearing is mounted at one of the first end portion of the shaft and the second end portion of the shaft. A stator is mounted within the housing and a rotor is mounted relative to the shaft and rotatable relative to the stator. A temperature sensor is integrated into the housing at the at least one bearing. The temperature sensor includes a sensing element that detects a temperature of the at least one bearing.

### BACKGROUND OF THE INVENTION

Exemplary embodiments pertain to the art of electric machines and, more particularly, to an electric machine having an integrated bearing temperature sensor.

Electric machines produce work from electrical energy passing through a stator to induce an electro-motive force in a rotor. The electro-motive force creates a rotational force at the rotor. The rotation of the rotor is used to power various external devices. Of course, electric machines can also be employed to produce electricity from a work input. In either case, electric machines are currently producing greater outputs at higher speeds and are being designed in smaller packages. The higher power densities and speeds often result in harsh operating conditions such as high internal temperatures, vibration and the like. Accordingly, many conventional electric machines include sensors that monitor, for example stator temperature, housing temperature and the like. The sensors typically take the form of temperature or vibration sensors that are mounted to an external housing of the electric machine. The sensors include a separate wiring harness that is coupled to, for example, a controller that reads and/or records sensed data.

### BRIEF DESCRIPTION OF THE INVENTION

Disclosed is an electric machine includes a housing and a shaft arranged within the housing. The shaft includes a first end portion and a second end portion. At least one bearing is mounted to one of the first end portion of the shaft and the second end portion of the shaft. A stator is mounted within the housing and a rotor is mounted relative to the shaft and rotatable relative to the stator. A temperature sensor is integrated into the housing at the at least one bearing. The temperature sensor includes a sensing element that detects a temperature of the at least one bearing.

Also disclosed is a method of operating an electric machine electrically connected to a motor control panel. The electric machine includes a housing, a stator mounted within the housing, and a shaft including a rotor mounted adjacent the stator. The method includes rotating the rotor operatively connected to at least one bearing relative to the stator, sensing a temperature of the at least one bearing with a temperature sensor integrated into the housing, passing power to the electric machine through a wire harness electrically coupled between the stator and the motor control panel, and passing signals representing the temperature of the at least one bearing through signal lines carried by the wire harness and electrically connected between the temperature sensor and the motor control panel.

### BRIEF DESCRIPTION OF THE DRAWINGS

The following descriptions should not be considered limiting in any way. With reference to the accompanying drawings, like elements are numbered alike:

FIG. 1 is a partial, cross-sectional view of an electric machine including an integrated bearing sensor in accordance with an exemplary embodiment; and

FIG. 2 is a partial cross-sectional view of an electric machine including an integrated bearing sensor in accordance with another exemplary embodiment.

### DETAILED DESCRIPTION OF THE INVENTION

A detailed description of one or more embodiments of the disclosed apparatus and method are presented herein by way of exemplification and not limitation with reference to the Figures.

Exemplary embodiments provide a temperature sensor that is integrated directly into an electric machine. The temperature sensor is positioned adjacent to bearings that enable a rotor to rotate relative to a stator. The temperature sensor provides feedback relating to bearing temperature. Monitoring bearing temperature enhances machine reliability by providing an indicator a potential failure mode. That is, operating parameters of the electric machine, such as coolant flow, can be adjusted based on bearing temperature to avoid a potential bearing failure. Also, integrating the temperature sensor into the electric machine eliminates any need for additional wiring harnesses or additional external connections that increase cost, complexity, and an overall number of potential failure points.

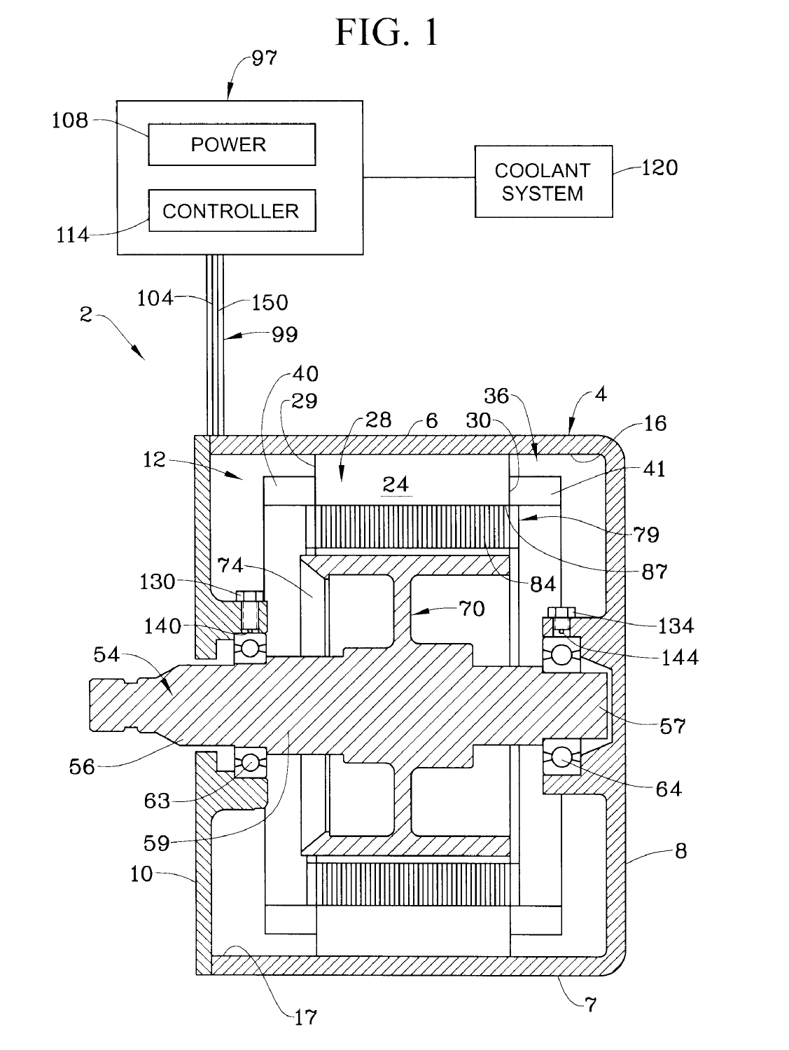

An electric machine in accordance with an exemplary embodiment is indicated generally at 2 in FIG. 1. Electric machine 2 includes a housing 4 having first and second side walls 6 and 7 that are joined by a first end wall 8 and a second end wall or cover 10 to collectively define an interior portion 12. First side wall 6 includes an inner surface 16 and second side wall 7 includes an inner surface 17. At this point it should be understood that housing 4 could also be constructed to include a single side wall having a continuous inner surface. Electric machine 2 is further shown to include a stator 24 arranged at inner surfaces 16 and 17 of first and second side walls 6 and 7. Stator 24 includes a body 28 having a first end portion 29 that extends to a second end portion 30 that supports a plurality of windings 36. Windings 36 include a first end turn portion 40 and a second end turn portion 41.

Electric machine 2 is shown to include a shaft 54 rotatably supported within housing 4. Shaft 54 includes a first end 56 that extends to a second end 57 through an intermediate portion 59. First end 56 is rotatably supported relative to second end wall 10 through a first bearing 63 and second end 57 is rotatably supported relative to first end wall 8 through a second bearing 64. Shaft 54 supports a rotor 70 that is rotatably mounted within housing 4. Rotor 70 includes a hub 74 that is fixed relative to intermediate portion 59, and a rotor lamination assembly 79. Rotor lamination assembly 79 includes a plurality of laminations, one of which is indicated at 84. Laminations 84 are stacked and aligned to define an outer diametric surface 87 of rotor lamination assembly 79.

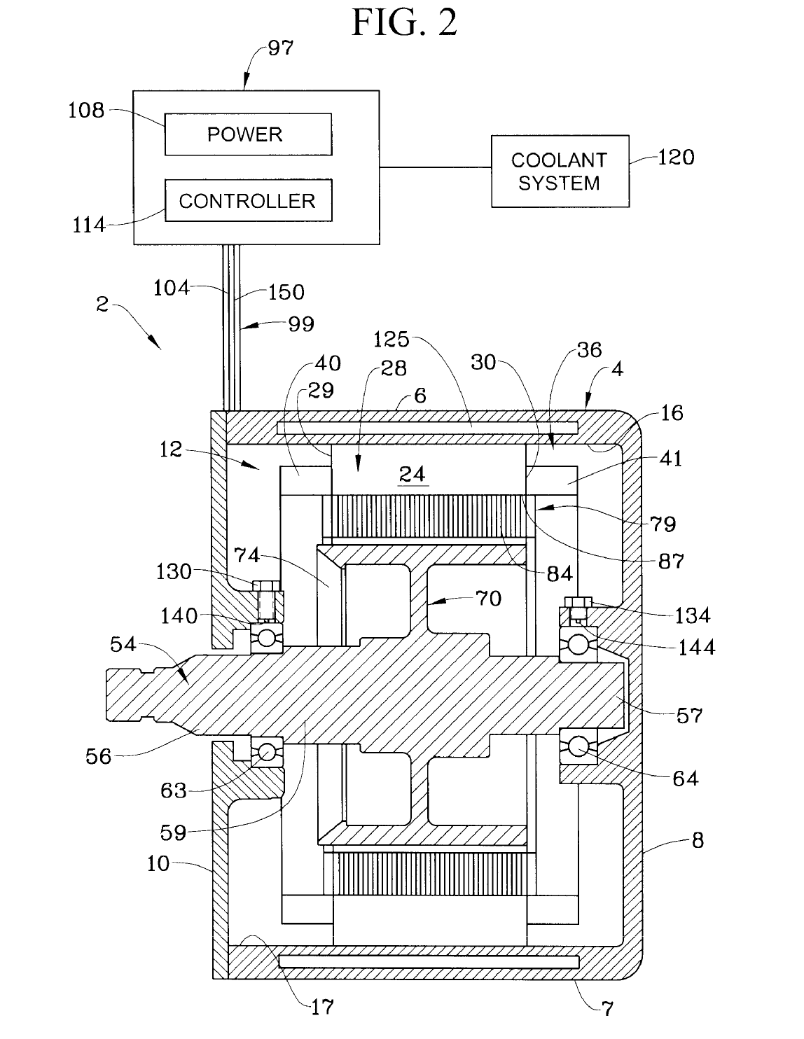

Electric machine 2 is electrically connected to a motor control panel 97 through a wire harness 99. Wire harness 99 includes a plurality of power conductors, one of which is indicated at 104, that electrically couple stator 24 with a power source 108 having terminals (not shown) arranged in motor control panel 97. Motor control panel 97 also houses a controller 114 that may be employed to control motor starting, motor speed, and/or motor shut down, as well as various other operating parameters. In the exemplary embodiment shown, controller 114 is linked to a coolant system 120 that delivers a flow of coolant, such as oil, airflow or the like, through housing 4. By “through” it should be understood that coolant system 120 may be configured to pass a flow of coolant, such as air or oil, directly onto rotor 70, first and second bearings 63 and 64 and/or first and second end turn portions 40 and 41 of stator 24, or indirectly through housing 4 such as by flowing a coolant, such as through a water jacket 125 as shown in FIG. 2 wherein like reference numbers represent corresponding parts in the respective views.

In further accordance with an exemplary embodiment, electric machine 2 includes a first temperature sensor 130 mounted within housing 4 at first bearing 63 and a second temperature sensor 134 mounted within housing 4 at second bearing 64. First and second temperature sensors 130 and 134 are integrated into housing 4 and configured to detect temperatures of first and second bearings 63 and 64 respectively. First temperature sensor 130 includes a first sensing element 140 that is in direct contact with first bearing 63. The term “direct contact” should be understood to include the presence of various elements that may enhance contact between first sensing element 140 and first bearing 63. In accordance with one aspect of the exemplary embodiment first sensing element 140 takes the form of a thermistor. However, it should be understood that other direct contact sensing elements such as resistance temperature devices (RTDs), or thermocouples can also be employed.

Conversely, second temperature sensor 134 indirectly detects a temperature of second bearing 64. More specifically, second temperature sensor 134 includes a second sensing element 144 that is positioned remote from second bearing 64. In accordance with one aspect of the exemplary embodiment, second sensing element 144 takes the form of an infra-red sensor, however it should be understood that other non-contact sensing elements can also be employed. First and second temperature sensors 130 and 134 are electrically linked to controller 114 through sensing lines, one of which is indicated at 150 that pass through wire harness 99 alongside power conductors 104. In accordance with one aspect of the exemplary embodiment, controller 114 receives signal input from first and second temperature sensors 130 and 134 representative of temperatures of first and second bearings 63 and 64. If the signal indicates a low temperature at first and/or second bearing 63, 64, coolant flow may be reduced. Conversely, if the signal indicates a high temperature at first and/or second bearing 63, 64, the coolant flow may be increased. Based on the signal, controller 114 may adjust a coolant flow from coolant system 120 in order to ensure that first and second bearings 63 and 64 do not over-heat. Of course, the temperature of first and second bearings 63 and 64 may simply be monitored to provide an indication of a need for any necessary replacement and/or repair.

At this point, it should be understood that the exemplary embodiment describe an electric machine having integrated temperatures sensors that provide real-time temperature information to a controller. Based on the temperature information, the controller may take corrective action or simply collect data to aid in predicting a need for service. Also, integrating the temperature sensor into the electric machine eliminates the need for additional cables, wiring harnesses or other external connections that increase cost, complexity, and an overall number of potential failure points. Although shown in connection with an electric machine having a rotating shaft to which is affixed a rotor, one of ordinary skill in the art would appreciate that the exemplary embodiments are also applicable to electric machines that include a rotor that is rotatably mounted to a fixed shaft. In addition, while shown with one non-contact temperature sensor and one contact temperature sensor, one of ordinary skill in the art would appreciate that the first and second temperature sensors could both be either non-contact sensors or sensors that directly contact the bearings.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An electric machine comprising:
a housing;
a shaft arranged within the housing, the shaft including a first end and a second end;
at least one bearing mounted at one of the first end of the shaft and the second end of the shaft;
a stator mounted within the housing;
a rotor mounted relative to the shaft and rotatable relative to the stator; and
a temperature sensor integrated within the housing at the at least one bearing, the temperature sensor including a sensing element that detects a temperature of the at least one bearing.

2. The electric machine according to claim 1, further comprising: coolant system configured and disposed to guide a coolant through the housing.

3. The electric machine according to claim 1, further comprising: a controller mounted in the motor control panel and operatively connected to the coolant system and the temperature sensor, the controller being configured and disposed to control coolant flow through the housing based on the temperature detected by the sensing element.

4. The electric machine according to claim 1, wherein the at least one bearing includes a first bearing arranged at the first end of the shaft and a second bearing arranged at the second end of the shaft, the temperature sensor being integrated within the housing at the first bearing.

5. The electric machine according to claim 4, further comprising: another temperature sensor integrated into the housing at the second bearing.

6. The electric machine according to claim 1, wherein the sensing element directly contacts the at least one bearing.

7. The electric machine according to claim 6, wherein the temperature sensor is one of a thermistor, a resistance temperature device (RTD), and a thermocouple.

8. The electric machine according to claim 1, wherein the temperature sensor is a non-contact sensor.

9. The electric machine according to claim 8, wherein the non-contact sensor is an infra-red (IR) sensor.

10. The electric machine according to claim 1, wherein the rotor is fixedly mounted to the shaft.

11. A method of operating an electric machine electrically connected to a motor control panel, the electric machine having a housing, a stator mounted within the housing, and a shaft including a rotor mounted adjacent the stator, the method comprising:
rotating the rotor operatively connected to at least one bearing relative to the stator;
sensing a temperature of the at least one bearing with a temperature sensor integrated into the housing;
passing power to the electric machine through a wire harness electrically coupled between the stator and the motor control panel; and
passing signals representing the temperature of the at least one bearing through signal lines carried by the wire harness and electrically connected between the temperature sensor and the motor control panel.

12. The method of claim 11, further comprising: adjusting the flow of coolant based on the temperature of the at least one bearing.

13. The method of claim 11, wherein sensing a temperature of at least one bearing with a temperature sensor integrated into the housing includes sensing a temperature of a first bearing with a first temperature sensor integrally mounted within the housing and a sensing a temperature of a second bearing with a second sensor integrally mounted within the housing.

14. The method of claim 11, wherein sensing a temperature of at least one bearing with a temperature sensor integrated into the housing includes directly sensing the temperature of the at least one bearing.

15. The method of claim 14, wherein directly sensing the temperature of the at least one bearing includes sensing the temperature of the at least one bearing with one of a thermistor and a resistance temperature device (RTD).

16. The method of claim 11, wherein sensing a temperature of at least one bearing with a temperature sensor integrated into the housing includes indirectly sensing a temperature of the at least one of the first and second bearings.

17. The method of claim 16, wherein indirectly sensing a temperature of the at least one bearing includes sensing the temperature of the at least one bearing with an infra-red temperature sensor.

18. The method of claim 11, wherein rotating the rotor operatively connected to at least one bearing relative to the stator includes rotating the rotor fixedly mounted to the shaft.

19. The method of claim 11, further comprising: passing a flow of coolant through the housing.

20. The method of claim 19, further comprising: controlling the flow of coolant based on the temperature of the at least one bearing.
